(19) United States
(12) Patent Application Publication
(10) Pub. No.: US 2011/0152419 A1
(43) Pub. Date: Jun. 23, 2011

(54) Antimony-free and cobalt-free polyethylene terephthalate resin composition

(75) Inventor: Zo-Chun Jen, Taipei (TW)

(73) Assignee: NAN YA PLASTICS CORPORATION, Taipei (TW)

(21) Appl. No.: 12/926,720

(22) Filed: Dec. 7, 2010

(30) Foreign Application Priority Data
Dec. 18, 2009 (TW) 098143532

(51) Int. Cl. C08K 5/53

(52) U.S. Cl. 524/131

(57) ABSTRACT

A polyethylene terephthalate (PET) resin composition features fast solid-state polymerization and low reproduction of acetaldehyde and cyclic oligomer when processed. In polymerization thereof, a titanium-containing compound is used as a catalyst for polycondensation, and a phosphoric stabilizer and an organic dye are introduced to prevent a yellowish hue of the resultant polyester, while a compound represented by the following formula (I) that contains phosphorus and calcium is added to accelerate solid-state polymerization of the PET pre-polymer and to endow the composed PET resin with better processability so that when processed for making a preform, the PET resin reproduces reduced acetaldehyde and cyclic oligomer.

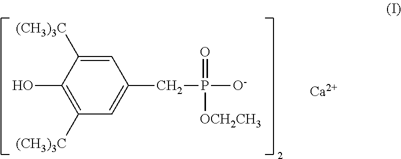

### BACKGROUND OF THE PRESENT INVENTION

1. Field of the Present Invention

The present invention relates to a polyethylene terephthalate resin composition, and more particularly, to an antimony-free and cobalt-free polyethylene terephthalate resin composition, which at least contains titanium elements, organic dyes and a specific compound containing hindered phenol, phosphorus and calcium, having higher solid-state polymerization rate remarkably improved and less reproduction of acetaldehyde and cyclic oligomer when processed.

2. Description of Prior Art

A conventional process for producing polyethylene terephthalate (hereinafter referred to as the “PET”) is to react purified terephthalic acid (TA) and ethylene glycol (EG) by a direct esterification reaction to yield bis(2-hydroxyethyl) terephthalate (i.e., monomer) and oligomers and water. This reaction is reversible and thus can be carried to completion by removing the water during the direct esterification process. The direct esterification process does not require a catalyst and conventionally no catalyst is employed.

The monomer then undergoes a polycondensation process to form PET. The polycondensation process typically uses antimony as a polycondensation catalyst. If necessary, a solid-state polymerization process may optionally follow the polycondensation process to increase the molecular weight of the resultant PET resins.

Recently, PET bottles have dominated over in drink-packaging applications and have almost replaced all kinds of glass bottles and aluminum cans. However, trace migration of antimony (Sb) from a PET bottle is capable of migrating into the drink contained therein, and it has been proven that the heavy metal, e.g. antimony, has seriously threatened to human health.

For solving this problem mentioned above, the process for producing PET have been taught to use a titanium-containing catalyst to replace the antimony catalyst as a polycondensation catalyst during the polycondensation process to form the PET.

For example, U.S. Pat. No. 5,922,828 employs an organic tetrabutyltitanate (also known as TBT) as a titanium-containing catalyst and employs bis(2,4-di-tert-butylphenyl) pentaerythritol diphosphite (commercially named as Anti-Oxidant AT-626) as a stabilizer to reduce acetaldehyde concentration in the synthesized polymer. Nevertheless, this prior art fails to overcome the problem of the finished PET looking yellowish.

U.S. Pat. No. 6,013,756 uses an organic tetrabutyl titanate compound as a titanium-containing catalyst during the polycondensation process of manufacturing PET and utilizes by addition of cobalt acetate to eliminate the defective yellowish appearance of the PET.

The embodiments disclosed in U.S. Pat. No. 6,500,915 also involves in using tetrabutyltitanate (TBT), phosphide and magnesium acetate to synthesize PET. However, this prior art provides no solution for elimination of the defective yellowish appearance of PET synthesized in the presence of the titanium-containing catalyst.

U.S. Pat. No. 6,593,447 has disclosed a polycondensation catalyst. For making the polycondensation catalyst organic titanium and phosphorous compounds are mixed in a certain proportion and dissolved in glycol to prepare a catalyst solution. The catalyst solution then reacts with anhydride under 200° C. to produce the polycondensation catalyst. However, this prior art provides no solution for elimination of the defective yellowish appearance of PET synthesized in the presence of titanium-containing catalyst.

U.S. Pat. No. 6,667,383 relates to PET synthesized in the presence of tetrabutyltitanate (TBT), phosphate esters and magnesium compounds. Yet, this prior art provides no solution for elimination of the defective yellowish appearance of PET synthesized in the presence of titanium-containing catalyst.

U.S. Pat. Nos. 6,489,433 and 6,541,598 respectively employ organic tetrabutyltitanate (TBT) or organic tetraisopropyl titanate as the polycondensation catalyst and additionally use a phosphonate ester to synthesize PET with desired color.

U.S. Pat. Nos. 7,094,863 and 7,129,317 use organic titanium diisopropoxide bis(acetyl-acetonate) or organic tetrabutyltitanate (TBT) as the polycondensation catalyst to synthesize PET. Bottle preforms made thereof provides with specific features of being bright and highly transparent and having low concentration of metal elements therein. Hot-filling bottles formed from such bottle preforms still maintain excellent transparency and desired dimensional stability at a filling temperature ranging from 195° F. to 205° F.

U.S. Pat. No. 6,451,959 teaches a solid titanium compound T that is prepared by hydrolyzing a titanium halide to obtain a hydrolyzate and then dehydro-drying the hydrolyzate. According to the cited prior art, the solid titanium compound T may be combined with other compounds E, such as Be-hydroxide, Mg-hydroxide, Ca-hydroxide, Sr-hydroxide or Ba-hydroxide. Therein, E/Ti molar ratio is between 1/50 and 50/1 while OH/Ti molar ratio is between 0.09 and 4.

U.S. Pat. No. 7,300,998 relates to a polycondensation catalyst applicable to synthesis of PET used for making bottles. Therein, Mg(OH)₂ and TiCl₄ are mixed in water to form an aqueous solution. Ammonia water is then added therein drop by drop to adjust the aqueous solution to about pH 9. Successively, an aqueous acetic acid solution is added therein drop by drop to adjust the aqueous solution to about pH 5. After filtering, washing and dissolving in ethylene glycol, the solution is treated by a centrifuge to have solid therein separated. The solid is then dried in vacuum at 40° C. for 20 hours before being ground into powders sized between 10 and 20 μm. The powders are afterward mixed with an ethylene glycol solution containing sodium hydroxide so as to obtain the polycondensation catalyst for use in synthesis of PET bottles. By using the sodium hydroxide, the cited prior art provides a polyester having high solid-state polycondensation rate and low concentration of regenerated acetaldehyde. However, this prior art provides no solution for elimination of the defective yellowish appearance of PET synthesized in the presence of titanium-containing catalyst.

Publication No. WO 2008/001473 is disclosed a polycondensation catalyst for polyester production. The polycondensation catalyst is a titanium-containing catalyst produced by reacting an aqueous MgCl₂ solution with an aqueous NaOH solution at 170° C. for 30 minutes approximately, and the reacted solution is then filtered and washed to form an aqueous Mg(OH)₂ slurry. On the other hand, an aqueous TiCl₄ solution and an aqueous NaOH solution are mixed before being added into the Mg(OH)₂ slurry. After the mixed aqueous TiCl₄ and NaOH solution added drop by drop into the Mg(OH)₂ slurry, the mixture is stirred for one hour for aging until TiO₂ embraces on the outer surface of Mg(OH)₂ in the slurry. Afterward, the slurry is filtered and washed to get solid part therein. The solid is dried and pulverized into powders that are later mixed with ethylene glycol to form a solution for use in polycondensation. As disclosed in the cited publication, the reaction rate of the polycondensation catalyst and the color of the polyester synthesized in the presence of the polycondensation catalyst are similar to those of Antimony trioxide (Sb₂O₃).

U.S. Pat. No. 5,747,606 has proposed a process wherein a hindered phenol-containing phosphorous compound is blended with PET to increase the molecular weight of polyesters and thereby improve the intrinsic viscosity (IV) of recycled PET.

U.S. Published Application No. 2009/0137769 disclosed a prepolyester that contains titanium and phosphorus and has an intrinsic viscosity of from 0.48 to 0.52 dl/g, wherein the prepolyester is subject to later time-consuming solid-state polymerization for reducing acetaldehyde and cyclic oligomer.

However, the existing PET resin made through the prior-art approaches, where titanium catalysts are used, disadvantageously have yellowish hues and, when processed, tend to produce high acetaldehyde and cyclic oligomer due to thermal degradation they perform. While high acetaldehyde contents bring an adverse impact to drinks received in the resultant PET containers, high cyclic oligomer contents usually cause adherence of the PET materials to the processing molds, which requires frequent shutdown cleaning, or otherwise degrades the transparency of the resultant PET containers.

On the other hand, because dyes added during PET polymerization are hardly useful to bleach the yellowish hues, additional cobalt acetate is conventionally used to improve the appearance of products. However, as cobalt is a helper to thermal degradation in the course of processing PET, it is also unfavorable to the transparency of PET products.

Additionally, throughout the technology of PET polyester, there has never been a technical literature teaching or disclosing the use of titanium catalyst and addition of a specific compound in PET polymerization for the purposes of accelerating solid-state polymerization of PET pre-polymer and lowering acetaldehyde as well as cyclic oligomer in the composed PET resin.

### SUMMARY OF THE INVENTION

In view of this, it is the primary objective of the present invention to provide an antimony-free and cobalt-free polyethylene terephthalate (PET) resin composition. In polymerization of the PET resin, a titanium-containing compound is implemented as a catalyst for polycondensation, and a phosphorous stabilizer and an organic dye are used, so as to prevent a yellowish hue of the polyester, while a compound contains hindered phenol, phosphorus and calcium is introduced to accelerate solid-state polymerization of the PET pre-polymer and improve the processability of the PET resin, so that when processed for making a PET bottle preform, the PET resin leads to lowered reproduction of acetaldehyde and cyclic oligomer.

An antimony-free and cobalt-free PET resin composition of the invention, having an intrinsic viscosity of from 0.68 to 0.85 dl/g, comprises

a polyethylene terephthalate (PET),
a compound containing hindered phenol, phosphorus and calcium and represented by the following formula (I) in an amount of 300-1,300 ppm by weight of the PET,

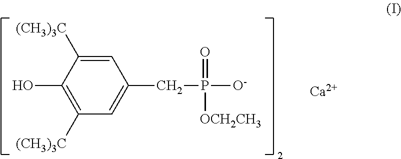

a titanium element in an amount of 3-15 ppm by weight of the PET,
a phosphorus element in a total amount of 60-150 ppm by weight of the PET, and
an organic dye in an amount of 0.5-3 ppm by weight of the PET.

The PET resin of the present invention contains both titanium and the compound of formula (I) mentioned above, so has faster reaction in solid-state polymerization, and thereby reduces the manufacturing costs. In addition, the PET resin of the present invention has a desirably non-yellowish hue, and, when processed for making a PET bottle preform, generates less acetaldehyde and cyclic oligomer, so the preform or polyester bottle made therefrom advantageously has desired quality.

The PET resin of the present invention further contains ferrous ferric oxide (Fe₃O₄), which helps to make the preform ripen faster.

### DETAILED DESCRIPTION OF THE PREFERRED EMBODIMENT

The present invention provides a prepolymerized polyethylene terephthalate (PET) made of diacid and diol, wherein, purified terephthalic acid (PTA) and glycol (EG) are used as the main diacid component and diol component, respectively. The diacid component and diol component, after direct esterification and subsequent polycondensation, make the intrinsic viscosity of the prepolymer reach 0.53-0.65 dl/g. The prepolymer is then extruded and quenched before being cut into amorphous prepolymerized chips (hereinafter referred to as the “raw granular PET”). The produced raw granular PET has to undergo subsequent solid-state polymerization (abbreviated as SSP) finishing for increasing the intrinsic viscosity to 0.68-0.85 dl/g.

The practical process for producing the PET resin of the present invention is described as follows.

### 1. First-Stage Direct Esterification Process

Purified terephthalic acid (PTA) and ethylene glycol (EG) are prepared in form of slurries and continuously pumped to one or more esterification tanks where the first-stage direct esterification process takes place. Number of esterification tank can be up to three.

The esterification process is performed at a material temperature ranging from 240° C. to 270° C., preferably from 250° C. to 260° C., under a processing pressure ranging from the atmospheric pressure to 2.0 kg/cm², preferably from 0.01 kg/cm² to 1.0 kg/cm², and for a reaction duration ranging from 3 to 8 hours, preferably from 4 to 6 hours.

Furthermore, a monomer conversion rate at the exit of the esterification tank is greater than 92%, preferably greater than 95%.

The vapor state of ethylene glycol and water generated during the direct esterification process are led to a distillation column through a vaporization pipe for separation and then the ethylene glycol collected at the bottom stream of the distillation column is refluxed to the esterification tank.

### 2. Second-Stage Polycondensation

Afterward, the monomer produced in the aforesaid esterification process is continuously pumped to a pre-polycondensation reactor to undergo the pre-polycondensation reaction. The pre-polycondensation reactor may comprise one vessel or two vessels. The pre-polycondensation process is performed at a material temperature ranging from 260° C. to 280° C., preferably from 250° C. to 260° C. under a processing pressure ranging from 10 mmHg to 200 mmHg. The by-products of vapor such as ethylene glycol generated during the pre-polycondensation process are condensed into a liquid. The residence time for the pre-polycondensation is between 0.5 hour and 2 hours.

The product produced from the pre-polycondensation process, is continuously pumped to a high vacuum finisher to undergo a further polycondensation reaction, so that the intrinsic viscosity is increased from 0.53 to 0.65 dl/g. The high vacuum finisher may comprise one vessel or two vessels of either a cage type or a disc type. The material temperature in the high vacuum finisher is from 265° C. to 290° C., preferably from 265° C. to 285° C., and most preferably from 265° C. to 280° C. In the finisher, a multi-stage ejector is employed to keep the vacuum pressure below 2 mmHg while the actually applied vacuum pressure is subject to the feedback control of the viscosity of the finished polymer.

The resultant polymer produced from the polycondensation process in the finisher is continuously withdrawn by a pump to a die head to be extruded and the extruded polymers are immediately cooled in chilled water and then are cut into amorphous chips by a cutter.

The raw granular PET of the present invention is made by using a titanium-containing compound as a catalyst for polycondensation (hereinafter referred to as the “titanium catalyst”), and adding a phosphoric stabilizer and an organic dye for preventing a yellowish hue.

The titanium catalyst may be added anytime prior to polycondensation. The titanium-containing catalyst may be an organic titanium catalyst, such as titanium tetrabutoxide, or an inorganic titanium catalyst, such as titanium dioxide series. For polycondensation, the amount of titanium is 3-15 ppm by weight of the polyethylene terephthalate. When the amount of titanium is less than 3 ppm, the reaction rate of melt polymerization is undesirably low, while when the amount of titanium is more than 15 ppm, the produced polyester is undesirably yellowish.

The organic dye is added prior to the end of direct esterification. The organic dye is mainly a blue dye, which may be Solvent Blue 122, Solvent Blue 104, Solvent Blue 98 or Solvent Blue 45. The blue dye is in an amount of 0.5-3 ppm, preferably of 0.5-2 ppm and most preferably of 0.5-1 ppm, by weight of the polyethylene terephthalate.

For preventing the raw granular PET of the present invention from becoming greenish, in addition to adding blue dye, a red dye may be further added if necessary. The red dye may be Solvent Red 179, Solvent Red 195 or a combination thereof. The red dye is, based on the weight of polyethylene terephthalate, not higher than 3 ppm, preferably not higher than 2 ppm and most preferably not higher than 1 ppm. Meantime, the proportion of the blue dye to the red dye is preferably 2:1-1:1 by weight, because excessive addition of the red dye may degrade the brightness of the raw granular PET.

The phosphoric stabilizer may be introduced anytime prior to polycondensation. The phosphoric stabilizer may be phosphoric acid, phosphorous acid or phosphate, wherein the content of phosphorus is 3-30 ppm, preferably 10-20 ppm, by weight of polyethylene terephthalate.

The raw granular PET of the present invention contains a compound represented by the following formula (I), wherein the compound contains hindered phenol, phosphorus and calcium.

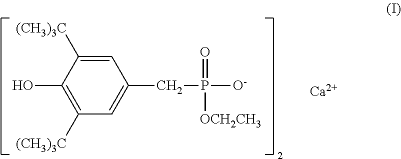

The compound of formula (I) may be introduced at any stage before the PET pre-polymer is granulated. The compound of formula (I) is used in an amount of 300-1,300 ppm, preferably 350-700 ppm, by weight of polyethylene terephthalate. When coming less than 300 ppm, the compound of formula (I) hardly helps to speed up solid-state polymerization, yet when exceeding 1,300 ppm, it retards melt polycondensation and leads to less transparent products, such as bottles, plates or films.

The raw granular PET of the present invention contains both of the phosphorous series stabilizer and the compound represented by formula (I), wherein the total content of phosphorus is in an amount of 60-150 ppm by weight of the polyethylene terephthalate.

In the composition of the PET prepolymer according to the present invention, in addition to purified terephthalic acid, isophthalic acid may be used as an additional diacid component in an amount of 0-10 mol % based on total diacid. Meantime, in additional to glycol and diglycol that is formed in the process, diglycol or 1,4-cyclohexanedimethanol may be used as an additional diol component in an amount of 1.0-10 mol % based on total diol.

If it is desired, the raw granular PET of the present invention may additionally contain ferrous ferric oxide (Fe3O4), so that the resultant polyester facilitates saving energy consumed by the infrared lamp for bottle blowing, speeding up bottle blowing and reducing the time required by preform ripening. The ferrous ferric oxide may be used in an amount of 2-50 ppm by weight of the polyethylene terephthalate.

Aside from the above-recited components, the raw granular PET of the present invention, like other polyesters, has residual of cyclic oligomer and acetaldehyde.

The raw granular PET of the present invention has to undergo a solid-state polymerization (SSP) finishing for increasing its intrinsic viscosity to 0.68-0.85 dl/g, so as to become the desired end-product of PET resin. By increasing the intrinsic viscosity, not only can the strength of the product be improved, but also cyclic oligomer and acetaldehyde remaining in the PET rein can be reduced. For performing solid-state polymerization, a continuous solid-state polymerization plants, provided by Swiss Buhler, Italian Sinco or American Bepex, are useful.

The PET resin of the present invention are used in manufacturing PET hot-filling bottles by a conventional one-stage bottle making method or two-stage bottle making method.

In the case where the one-stage bottle making method is adopted, the PET resins are directly melt in a PET stretch blow molding machine at a melting temperature ranging from 270° C. to 295° C. and made into bottle preforms. After a short cooling time, the bottle preforms can be stretched blown into PET hot-filling bottles directly.

In the case where the two-stage bottle making method is adopted, an injection blow molding machine is employed to make the PET resins into bottle preforms at a melting temperature ranging from 270° C. to 290° C. The preforms, after aging for days, are heated by near infrared lamps to temperature above the glass transition temperature thereof and blown into PET filling bottles.

The raw granular PET or the resultant PET resin of the present invention contains both titanium elements and the compound of formula (I) mentioned above, which has the following benefits:

1. As compared with a raw granular PET containing titanium but not the compound of formula (I), the raw granular PET of the invention containing both titanium and the compound of formula (I) has a higher solid-state polymerization rate.

In comparison, the raw granular PET containing titanium has a solid-state polymerization rate equal to 55-65% of that of a raw granular PET containing antimony. However, the raw granular PET containing both titanium and the compound of formula (I) shows a solid-state polymerization rate equal to 65-90% of that of the same raw granular PET containing antimony, which is higher than that of the raw granular PET only containing titanium but not the compound of formula (I).

It is commonly known that a low rate of solid-state polymerization may leads to the following problems:

a) The raw granular PET containing titanium but not the compound of formula (I) needs higher temperature for solid-state polymerization to achieve the desired intrinsic viscosity. However, solid-state polymerization in higher temperature tends to make such a raw granular PET become yellowish, and even lead to caking PET resin in a solid-state polymerization tank, causing solid-state polymerization and in turn the production unstable.

b) The raw granular PET containing titanium but not the compound of formula (I) has a lower solid-state polymerization rate, so its melt polymerization and solid-state polymerization are unbalanced in yield. Once the production of the raw granular PET gets ahead to a certain extent, the melt polymerization device has to be shut down from making more raw granular PET, and this is no doubt a significant economical loss.

2. The PET resin of the invention containing titanium and the compound of formula (I), when melt and processed, generates less acetaldehyde as compared with the PET resin that only contains titanium but not the compound of formula (I).

In comparison, the PET resin that contains titanium but not the compound of formula (I), when melt for making a PET preform, the preform has more acetaldehyde as compared with a PET preform containing antimony.

In practice, a mass manufactured antimony-containing PET preform having 2 liter capacity contains acetaldehyde in an amount of 5-10 ppm, and averagely of about 8 ppm. A titanium-containing PET preform of the same capacity contains acetaldehyde in an amount of 8-15 ppm, and averagely of about 12 ppm. A PET preform of the same capacity containing both titanium and the compound of formula (I) has acetaldehyde in an amount of 6-12 ppm, and averagely of about 10 ppm, lower than that contained in a PET preform only containing titanium but not the compound of formula (I).

3. The PET resin of the invention containing both titanium and the compound of formula (I), when melt and processed, reproduces less cyclic oligomer as compared with the PET resin only containing titanium but not the compound of formula (I).

The PET resin only containing titanium but not the compound of formula (I), when melt and processed for making a PET preform, the preform has more cyclic oligomer as compared with an antimony-containing PET preform.

In practice, a mass manufactured antimony-containing PET preform having 2 liter capacity contains cyclic oligomer in an amount of 0.58-0.63%, and averagely of about 0.60%. A titanium-containing PET preform of the same capacity contains cyclic oligomer in an amount of 0.70-0.80%, and averagely of about 0.75%. A PET preform of the same capacity containing both titanium and the compound of formula (I) has cyclic oligomer in an amount of 0.60-0.70%, and averagely of about 0.65%, lower than that contained in a PET preform only containing titanium but not the compound of formula (I).

The following examples and comparative examples are provided for illustrating and demonstrating the effects of the present invention, it is to be noted that the scope of the present invention is not limited to the recited embodiments.

### Test Method for Determining Inherent Viscosity

Based on ASTM D-4603, the IV is analyzed by an Ubbelohde viscometer at 25° C. in a mixed solvent of phenol and tetra-chloro ethane mixed in a ratio of 3:2.

### Methods of Colour Measurement

Based on JIS Z 8722, the hues of the PET resin particles are taken by a spectrophoto meter from TOKYO DENSHOKU CO., LTD bearing the model no. TC-1800MK II, and are expressed by L/a/b.

### Acetaldehyde Concentration Analysis

Preforms made by injection are frozen in liquid nitrogen and then pulverized into powders. The powders are received in a cell that is sealed with a septum cap, and then the cell is treated by a heating process at 150° C. for 30 minutes. Afterward, gas in the cell is drawn by a sampling probe piercing the cap, and then the sampling probe feeds the gas sample to a gas chromatograph system for analyses.

### Cyclic Trimer Analysis:

A hexafluoride isopropyl alcohol solvent is used to dissolve the precisely weighted PET resins and prepare a limpid solution. The limpid solution is filtered in vacuum and the clear filtrate is then dried by evaporation to obtain a cyclic oligomer in the form of white crystals.

The white crystals are further dissolved in dioxane (or known as diethylene dioxide) to obtain another limpid solution. The latter limpid solution is introduced into a high-performance liquid chromatography system (HPLC) for LC analyses.

### Example 1

Bis(hydroxyethyl)terephtalate (BHET) monomer with an esterification rate of about 88% was obtained from an esterification tank in a continuous melt polymerization line. 10.81 kg of the BHET monomer was weighted and added with 3.23 kg of glycol (EG) as well as 0.1 g of phosphoric acid (containing 3 ppm phosphorus). The mixture was then heated to more than 190° C. for 2-hour esterification with the mixer set at 60 rpm and the esterification pressure set at about 1 kg/cm². At the end of esterification, the material temperature was about 240° C., and the esterification rate was higher than 95%. The post-esterification mixture was added with a titanium tetrabutoxide catalyst in glycol, which contained 3 ppm titanium by weight of the raw granular PET. A blue dye in glycol was also introduced in an amount of 1 ppm by weight of the raw granular PET. In addition, the compound represented by the following formula (I) dissolved in glycol was added in an amount of 6.5 g, with the compound equal to 650 ppm by weight of the raw granular PET while 0.16 g ferrous ferric oxide (Fe₃O₄) was added as well.

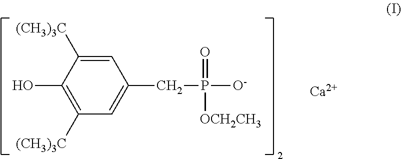

The post-esterification monomer then underwent vacuum prepolymerization, with the reaction pressure gradually reduced from 760 torr to 10 torr, the temperature at 240-255° C., and the reaction time set as 1 hour. Subsequently, primary polymerization was performed under high vacuum, with the reaction pressure lower than 1 torr, the reaction pressure gradually elevated from 255° C., while the viscosity of the polymerized matter was accordingly increased to the extent that under the same torque of the mixer, the rotation rate decreased by about 25 rpm. The polymerized matter was unloaded, quenched and cut into amorphous chips with the intrinsic viscosity (IV) of 0.610 dl/g and the reaction time of 87 minutes.

The raw granular PET was placed in a taper vacuum tank for solid-state polymerization (SSP) finishing. After 25 hours of solid-state polymerization, the raw granular PET had its intrinsic viscosity (IV) increased to 0.686 dl/g. The PET resin after SSP finishing was then used for injection blow moulding.

The raw granular PET, the PET resin after SSP finishing and the bottle preform such made thereof were analyzed for various items and the detailed results are listed in Table 1.

### Example 2

This Example is similar to the Example 1 except that titanium was in an amount of 6 ppm, and the phosphorous series stabilizer contained 15 ppm phosphorus, while the compound of formula (I) was in an amount of 500 ppm by weight of the polyester resin.

The raw granular PET, the PET resin after SSP finishing and the bottle preform such made thereof were analyzed for various items and the detailed results are listed in Table 1.

### Example 3

This Example is similar to the Example 1 except that titanium was in an amount of 6 ppm, and the phosphorous series stabilizer contained 15 ppm phosphorus, while the compound of formula (I) was in an amount of 800 ppm by weight of the raw granular PET.

The raw granular PET, the PET resin after SSP finishing and the bottle preform such made thereof were analyzed for various items and the detailed results are listed in Table 1.

### Example 4

This Example is similar to the Example 1 except that titanium was in an amount of 6 ppm, and the phosphorous series stabilizer contained 15 ppm phosphorus, while the compound of Formula (I) was in an amount of 1,300 ppm by weight of the raw granular PET.

The raw granular PET, the PET resin after SSP finishing and the bottle preform such made thereof were analyzed for various items and the detailed results are listed in Table 1.

### Example 5

This Example is similar to the Example 1 except that titanium was in an amount of 6 ppm, and the phosphorous series stabilizer contained 30 ppm phosphorus, while the compound of formula (I) was in an amount of 500 ppm by weight of the raw granular PET.

The raw granular PET, the PET resin after SSP finishing and the bottle preform such made thereof were analyzed for various items and the detailed results are listed in Table 1.

### Example 6

This Example is similar to the Example 1 except that titanium was in an amount of 10 ppm, and the phosphorous series stabilizer contained 30 ppm phosphorus, while the compound of formula (I) was in an amount of 500 ppm by weight of the raw granular PET.

The raw granular PET, the PET resin after SSP finishing and the bottle preform such made thereof were analyzed for various items and the detailed results are listed in Table 1.

### Example 7

This Example is similar to the Example 1 except that titanium was in an amount of 15 ppm, and the phosphorous series stabilizer contained 30 ppm phosphorus, while the compound of Formula (I) was in an amount of 500 ppm by weight of the raw granular PET and 2 ppm blue dye was added.

The raw granular PET, the PET resin after SSP finishing and the bottle preform such made thereof were analyzed for various items and the detailed results are listed in Table 1.

### Comparative Example 1

This Comparative Example is similar to Example 1 except that antimony was used as a catalyst for polycondensation with an antimony content of 180 ppm, and the phosphorous series stabilizer contained 110 ppm phosphorus, while the compound of formula (I) was in an amount of 350 ppm by weight of the raw granular PET and 90 ppm cobalt acetate as well as 2 ppm blue dye was added.

The raw granular PET, the PET resin after SSP finishing and the bottle preform such made thereof were analyzed for various items and the detailed results are listed in Table 1.

### Comparative Example 2

This Comparative Example is similar to Example 1 except that titanium was in an amount of 6 ppm, and the phosphorous series stabilizer contained 5 ppm phosphorus by weight of the raw granular PET, while the compound of formula (I) was not added.

The raw granular PET, the PET resin after SSP finishing and the bottle preform such made thereof were analyzed for various items and the detailed results are listed in Table 1.

### Comparative Example 3

This Comparative Example is similar to Example 1 except that titanium was in an amount of 6 ppm, and the phosphorous series stabilizer contained 20 ppm phosphorus, while the compound of formula (I) was in an amount of 50 ppm by weight of the raw granular PET.

The raw granular PET, the PET resin after SSP finishing and the bottle preform such made thereof were analyzed for various items and the detailed results are listed in Table 1.

### Comparative Example 4

This Comparative Example is similar to Example 1 except that titanium was in an amount of 6 ppm, and the phosphorous series stabilizer contained 20 ppm phosphorus, while the compound of formula (I) was in an amount of 300 ppm by weight of the raw granular PET.

The raw granular PET, the PET resin after SSP finishing and the bottle preform such made thereof were analyzed for various items and the detailed results are listed in Table 1.

### Comparative Example 5

This Comparative Example is similar to Example 1 except that titanium was in an amount of 6 ppm, and the phosphorous series stabilizer had 35 ppm phosphorus, while the compound of formula (I) was 1,400 ppm by weight of the raw granular PET.

The raw granular PET, the PET resin after SSP finishing and the bottle preform such made thereof were analyzed for various items and the detailed results are listed in Table 1.

### Results

By comparing the results of Examples 1-7 and Comparative Examples 1-5 shown in Table 1, the following conclusions can be achieved:

1. The resultant PET resin of Examples 1 through 7 did not contain antimony and cobalt, thus being harmless to human health. In addition, the raw granular PET of Examples 1 through 7 had high solid-state polymerization rates, thus being advantaged for the lowered manufacturing costs.

Moreover, the PET resins had good non-yellowish hues and, when processed for making PET bottle preforms, reproduced less acetaldehyde and cyclic trimer.

2. The raw granular PET of Comparative Examples 2-4 contained the compound of formula (I) of 300 ppm or less, and, according to Table 1, presented less catalysis to solid-state polymerization rate. On the other hand, the raw granular PET of Examples 1-7 contained the compound of formula (I) in the amounts of 500-1300 ppm, and, as compared with the results of Comparative Examples 2-4, showed solid catalytic effect on solid-state polymerization rate.

3. The raw granular PET of Comparative Example 2 did not contain the compound of formula (I). According to Table 1, the solid-state polymerization rate thereof was 0.0028 ΔIV/hr, lower than those of Examples 1 through 7 as shown in Table 1.

Therefore, it is verified that the PET resin of Examples 1 through 7 containing the compound of formula (I) of 500-1300 ppm were useful in increasing the solid-state polymerization rate.

4. The raw granular PET of Example 4 contained the compound of formula (I) of 1,300 ppm and the raw granular PET of Comparative Example 5 contained the compound of formula (I) of 1,400 ppm. By comparing the melt polymerization time thereof as shown in Table 1, it is confirmed that the raw granular PET contained the compound of formula (I) of 1,300 ppm was adverse to the melt polycondensation rate.

5. The PET resin of Examples 1 through 7 contained titanium element of 3-15 ppm and the compound of formula (I) of 500-1300 ppm, when processed for making PET bottle preforms, reproduced less acetaldehyde and cyclic trimer.

TABLE 1

| | |
|---|---|
| Example | Comparative Example |

| Item | | 1 | 2 | 3 | 4 | 5 | 6 | 7 | 1 | 2 | 3 | 4 | 5 |
|---|---|---|---|---|---|---|---|---|---|---|---|---|---|
| Polycondensation | | 3 ppm | 6 ppm | 6 ppm | 6 ppm | 6 ppm | 10 ppm | 15 ppm | 0 | 6 ppm | 6 ppm | 6 ppm | 6 ppm |
| catalyst | | | | | | | | | | | | | |
| containing Ti | | | | | | | | | | | | | |
| Polycondensation | | 0 | 0 | 0 | 0 | 0 | 0 | 0 | 180 ppm | 0 | 0 | 0 | 0 |
| catalyst | | | | | | | | | | | | | |
| containing Sb | | | | | | | | | | | | | |
| Stabilizer | | 3 ppm | 15 | 15 | 15 ppm | 30 ppm | 30 ppm | 30 ppm | 110 ppm | 5 ppm | 20 ppm | 20 ppm | 35 ppm |
| containing | | | ppm | ppm | | | | | | | | | |
| Phosphorus | | | | | | | | | | | | | |
| Formula (I) | | 650 | 500 | 800 | 1300 ppm | 500 ppm | 500 ppm | 500 ppm | 350 ppm | 0 | 50 ppm | 300 ppm | 1400 ppm |
| | | ppm | ppm | ppm | | | | | | | | | |
| Dye | Blue | 1 ppm | 1 ppm | 1 ppm | 1 ppm | 2 ppm | 1 ppm | 2 ppm | 2 ppm | 1 ppm | 1 ppm | 1 ppm | 1 ppm |
| | Dye | | | | | | | | | | | | |
| | cobalt | 0 | 0 | 0 | 0 | 0 | 0 | 0 | 90 ppm | 0 | 0 | 0 | 0 |
| | acetate | | | | | | | | | | | | |

| | | | | | | | | | | | | |
|---|---|---|---|---|---|---|---|---|---|---|---|---|
| Melt | 87 mins | 77 mins | 80 mins | 90 mins | 77 mins | 65 mins | 60 mins | 81 mins | 70 mins | 65 mins | 72 mins | 97 mins |
| Polymerization | | | | | | | | | | | | |
| Time | | | | | | | | | | | | |
| PET Color | +5.5 | +4.3 | +4.5 | +5.2 | +2.5 | +5.5 | +6.8 | +1.3 | +4.1 | +4.0 | +4.3 | +6.9 |
| b⁽¹⁾ Value | | | | | | | | | | | | |
| Raw | 0.610 | 0.618 | 0.620 | 0.617 | 0.615 | 0.613 | 0.611 | 0.635 | 0.630 | 0.639 | 0.624 | 0.609 |
| granular PET | | | | | | | | | | | | |
| IV (dl/g) | | | | | | | | | | | | |
| SSP finishing | 0.686 | 0.699 | 0.714 | 0.719 | 0.695 | 0.710 | 0.717 | 0.715 | 0.706 | 0.705 | 0.702 | 0.715 |
| PET resin | | | | | | | | | | | | |
| IV (dl/g) | | | | | | | | | | | | |
| SSP Rate | 0.003 | 0.0033 | 0.0038 | 0.0041 | 0.0032 | 0.0039 | 0.0042 | 0.0053 | 0.0028 | 0.0026 | 0.0031 | 0.0042 |
| (ΔIV/hr) | | | | | | | | | | | | |
| Preform | 15.1 | 14.3 | 13.7 | 15.6 | 12.4 | 17.7 | 19.9 | 13.9 | 23.8 | 25.4 | 14.4 | 15.5 |
| Acetaldehyde | | | | | | | | | | | | |
| (ppm) | | | | | | | | | | | | |
| Preform | 0.65 | 0.64 | 0.62 | 0.60 | 0.61 | 0.70 | 0.72 | 0.61 | 0.84 | 0.79 | 0.73 | 0.65 |
| cyclic trimer | | | | | | | | | | | | |
| (%) | | | | | | | | | | | | |

(1) The data were detected by a Hunter color meter, wherein the higher “b” value means the subject is more yellowish and the lower “b” value means the subject is more bluish.

What is claimed is:

1. An antimony-free and cobalt-free polyethylene terephthalate resin composition, having an intrinsic viscosity of from 0.68 to 0.85 dl/g, comprising
a polyethylene terephthalate (PET),
a compound represented by the following formula (I) in an amount of 300-1,300 ppm by weight of the polyethylene terephthalate, 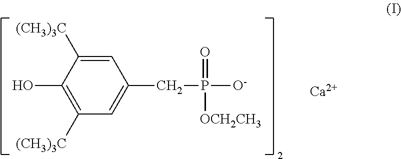
a titanium element in an amount of 3-15 ppm by weight of the polyethylene terephthalate,
a phosphorus element in a total amount of 60-150 ppm by weight of the polyethylene terephthalate, and
an organic dye in an amount of 0.5-3 ppm by weight of the polyethylene terephthalate.

2. The polyethylene terephthalate resin composition of claim 1, wherein the amount of the compound of formula (I) is 350-700 ppm by weight of the polyethylene terephthalate.

3. The polyethylene terephthalate resin composition of claim 1, further comprising a ferrous ferric oxide (Fe₃O₄) in an amount of 2-50 ppm by weight of the polyethylene terephthalate.

4. The polyethylene terephthalate resin composition of claim 1, wherein the organic dye is a blue dye.

5. The polyethylene terephthalate resin composition of claim 4, wherein the blue dye is selected from the group consisting of Solvent Blue 122, Solvent Blue 104, Solvent Blue 98 and Solvent Blue 45.

6. The polyethylene terephthalate resin composition of claim 4, wherein the organic dye further comprises a red dye, and a proportion of the blue dye to the red dye ranges between 2:1 and 1:1 by weight.

7. The polyethylene terephthalate resin composition of claim 6, wherein the red dye is selected from the group consisting of Solvent Red 179 and Solvent Red 195.

8. A preform made of the polyethylene terephthalate resin composition of claim 1.
